(19) United States
(12) Patent Application Publication
(10) Pub. No.: US 2010/0258772 A1
(43) Pub. Date: Oct. 14, 2010

(54) Apparatus and Methods for the Retensioning of Reinforcement Tendons

(76) Inventor: JOHN WILSON PARKIN, Vancouver, WA (US)

Correspondence Address: Smith-Root, Inc., 14014 NE Salmon Creek Ave, Vancouver, WA, 98686, US

(21) Appl. No.: 12/421,493

(22) Filed: Apr. 9, 2009

(51) Int. Cl. E04G 21/12; B23P 11/00; B25B 25/00

(52) U.S. Cl. 254/29 A; 29/452; 254/199

(57) ABSTRACT

An apparatus for retensioning tendons in a concrete slab which has a stressing frame with a first leg having a top part and a bottom part, and a second leg having a top part and a bottom part, so that the top part of the first leg and the top part of the second leg, are pivotally connected; and so that the first leg further comprises a shaft and wherein the bottom part of the second leg further comprises a shaft; and second leg further comprises a contact point proximate to the bottom part of the second leg; so that the bar engagedly connects the first leg so that when the retractor is engaged, the bar is pulled and the contact point on the first leg and the contact point on the second leg are pulled inwards allowing the two pieces of rebar tendons to be connected.

### RELATED APPLICATIONS

This application claims the benefit of U.S. Provisional Application No. 61/107,178 filed Oct. 21, 2008, the contents herein incorporated into this application by reference.

### BACKGROUND

The present inventive subject matter relates to an apparatus and the use of that apparatus in to splice tendons in restricted work areas for tensioned concrete.

The use of reinforcement tendons in concrete structures is a well known technique and familiar to those who practice in the civil engineering and structural engineering disciplines. In one type of construction, a concrete form is constructed, tendons (e.g., braided cables) are laid in the form, the concrete is poured and as it is setting, the cable is tensioned by placing stress on each end of the cables. The use of stressed tendons is necessary to overcome concrete's natural weakness in tension. The use of stressed tendons produces a compressive stress that offsets a tensile stress that is present on the concrete slab. In this type of construction, it is imperative that stress be maintained on the tendons to be effective.

In some cases, typically after a construction project is completed, the ends of the tendons are no longer accessible. This situation is fairly common, for example, during the construction of a building, after the slab is poured, the strand ends of the tendon may be cut off, followed by the mortaring of the access holes, with the access holes covered by a facia or curtain wall.

After the tendons are installed and the tendons are stressed, it may be necessary to cut into the concrete because of utility access or remodeling. When the slab is cut, the tendons may also be cut. This cutting of the tendons releases the stress and reduces the compressive force on the concrete slab. Since cutting the tendons reduces the reinforcement properties of the concrete, it is highly desirous to rejoin the cut tendon around the new opening to maintain the compressive force.

This is accomplished by lengthening the hole to allow a gentle tendon deviation around the opening, moving back some concrete to fix the new tendon path, then using standard commercially available couplers, chucks, and deviators, to join the tendon. After the joined tendon is tensioned, the remainder of the hole is filled with concrete.

One of the drawbacks of the traditional tendon splicing technique is that the jack or other pulling device has to be placed next to the tendon to complete the splice. In many cases, this requires extra space and enlarging the hole into other places where other tendons are active. Also, tendons are bundled into the slab into groups of up to five Splices have to be staggered and fitted into as small as space as possible.

Also with traditional methods of splicing, for example using a jack, may place the repairman in close proximity to the jack and therefore the tendon. Slippage of the jack and/or breakage of the tendon may result in possible injury to the repairman. Although, skilled post tensioning repairman are very aware of the risk of damage and take precautions, any device that would reduce the risk is of injury is desirable.

Therefore, what is desired is an apparatus that can aid in the resplicing of tendons that are placed in concrete.

### SUMMARY

The present inventive subject matter overcomes problems in the prior art by providing an apparatus for retensioning tendons, the apparatus having a stressing frame, said stressing frame comprising a first leg and a second leg, the first leg having a top part and a bottom part, and the second leg having a top part and a bottom part, wherein said top part of the first leg and the top part of the second leg, pivotally connected; and wherein the bottom part of the first leg further comprises a shaft and wherein the bottom part of the second leg further comprises a shaft; and wherein the first leg further hasa contact point proximate to the bottom part of the first leg; and wherein the second leg further has a contact point proximate to the bottom part of the second leg; and a bar, wherein said bar engagedly connects the first leg to the second leg; and wherein the bar has a first end and a second end; and a retractor, wherein the retractor is fixedly attached to the first end of the bar, and wherein the second end of the bar is connected to the retractor; so that when the retractor is engaged, the bar is pulled and the contact point on the first leg and the contact point on the second leg are pulled inwards.

The retensioning apparatus as indicated with stressing frame that is raised and lowered. The retensioning apparatus as indicated with a retractor as a mechanical ram. The retensioning apparatus as indicated with the retractor as a electrical motor. The retensioning apparatus as indicated wherein said first leg and said second leg is separated by a return spring. The retensioning apparatus wherein said stressing frame is from 1 to 5 feet in height. The retensioning apparatus as indicated wherein the stressing frame further comprises a caster, the caster attached to the base of the stressing frame.

A method of splicing a cut tendon, said method comprising the steps of: attaching a chuck to each end of the cut tendon, positioning a stressing frame over the cut tendon, lower the stressing frame over the cut tendon, engaging the legs of the stressing frame, so that when the legs of the stressing frame are engaged, the chucks are engaged and the tendons are pulled together and the ends of the tendonare fixed into a coupler which grips and maintains the tendon extension, so that a coupler joins the cut tendons.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a view of the prior art tendon coupling; diagram A of the prior art tendon in place prior to cutting; a diagram B of the cut tendon, and a diagram C of the tendon coupler installed. FIG. 1B is a prior art diagram of the tendon coupling system. FIG. 1C is a diagram of the desired configuration for coupling the two tendons.

FIG. 2 is a view of the preferred embodiment of the apparatus for tendon coupling; FIG. 2-1 is the tendon retensioner positioned above the hole; FIG. 2-2 is the tendon retensioner lowered into the hole positioned above the tendon; FIG. 2-3 is the tendon retensioner lowered into the hole with the tendon re-stressed.

FIG. 3 is a view of the preferred embodiment of the apparatus for tendon coupling. FIG. 3-1 is a corner view of the preferred embodiment for tendon coupling. FIG. 3-2 is a top view of the preferred embodiment for tendon coupling. FIG. 3-3 is a side view of the preferred embodiment for the tendon coupling device. FIG. 3-4 is a detailed view of the return spring. FIG. 3-5 is an edge view of the preferred embodiment of the tendon coupling device.

FIG. 4 is a detailed view of the support apparatus for the tendon re-tensioner. FIG. 4-1 is a corner view with the selected components in black. FIG. 4-2 is a detailed view of the roller. FIG. 4-3 is a detailed view of the cross member.

FIG. 5 is a detailed view of the connecting structure. FIGS. 5-1, 5-2, and 5-3 are representational views of the support structure as shown.

FIG. 6 is a detailed view of the upper support structure. FIGS. 6-1, 6-2, 6-3, and 6-4 show various views of the upper support structure.

FIG. 7 is a detailed view of the legs. FIG. 7-1 shows a corner view of the pair of legs as installed.

FIG. 8 is a top view of the use of couplers to join and re-route tendons to avoid a void created within the concrete structure.

### LIST OF REFERENCE CHARACTERS

110 —Slab
120 —Hole
130 —Tendon
140 —Tendon Break
150 —Coupler
160 —Stressing Chuck
170 —Backfill
200 —Tendon Retensioner
210 —Stressing Frame
220′, 220″—Left Leg, Right Leg
230—Pivot
235—Return Spring
240—Stressing Ram
245—Bar
250′, 250″—Chuck Contacts
300—Positioner
310—Support
320—Caster
330—Positioner Guides
500—Connecting Structure
600—Upper Support Structure
610—Upper Support Leaves
620—Upper Support Cross Member

### DETAILED DESCRIPTION

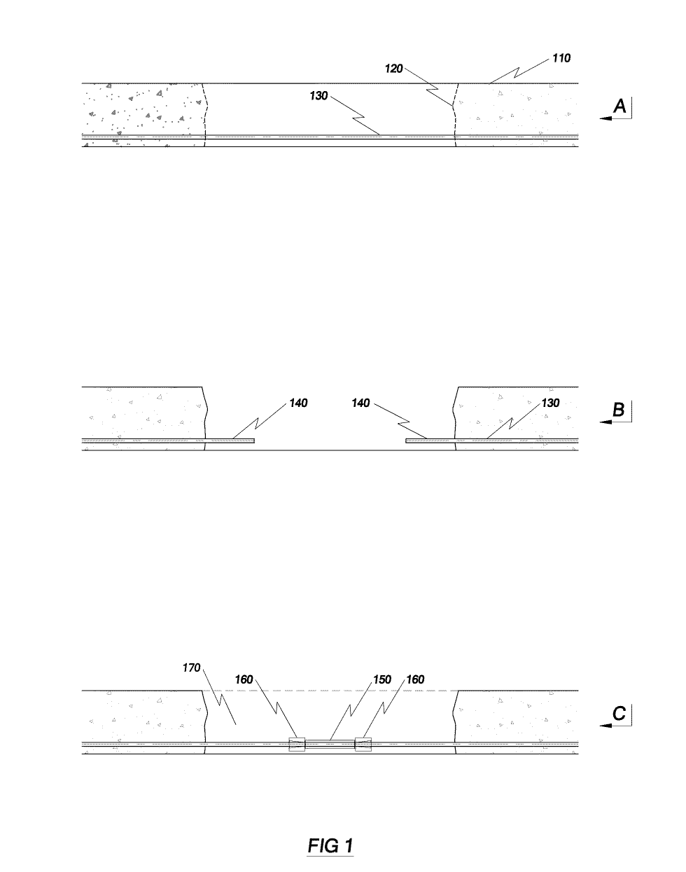

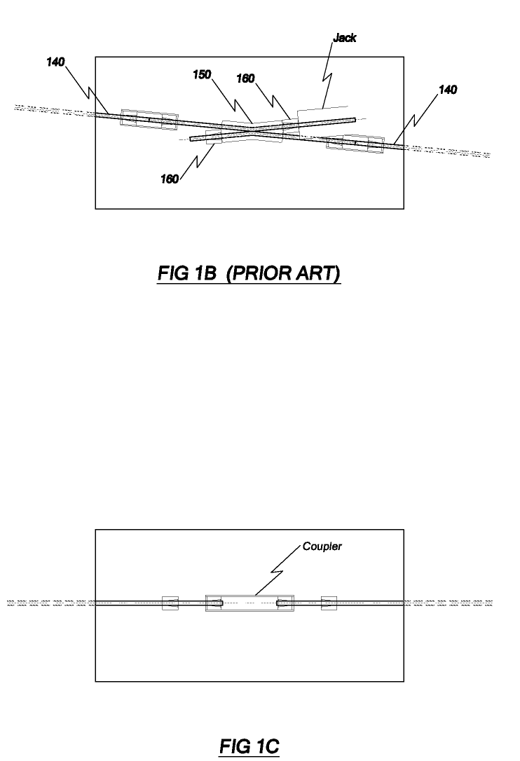

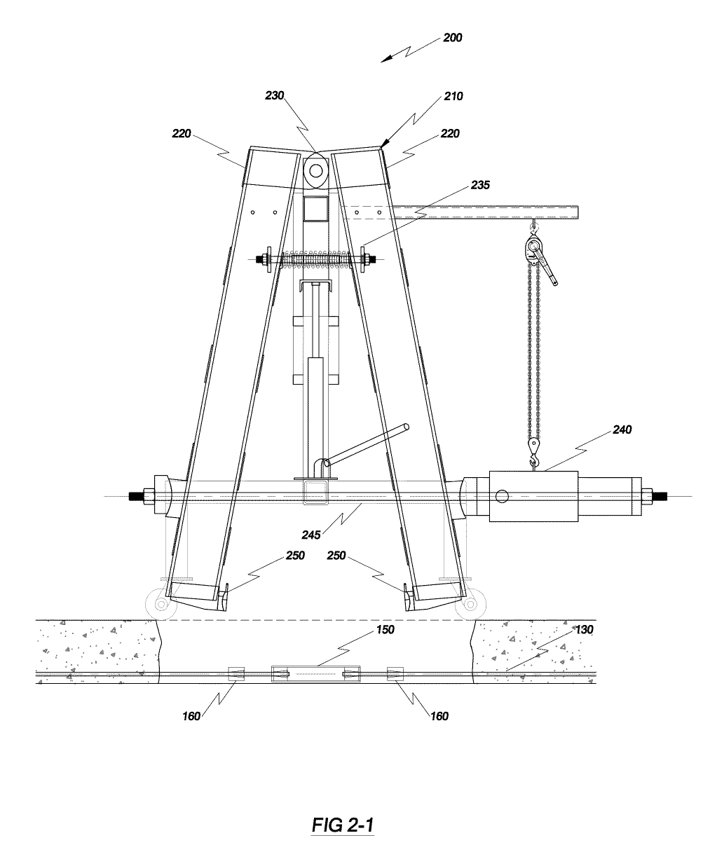

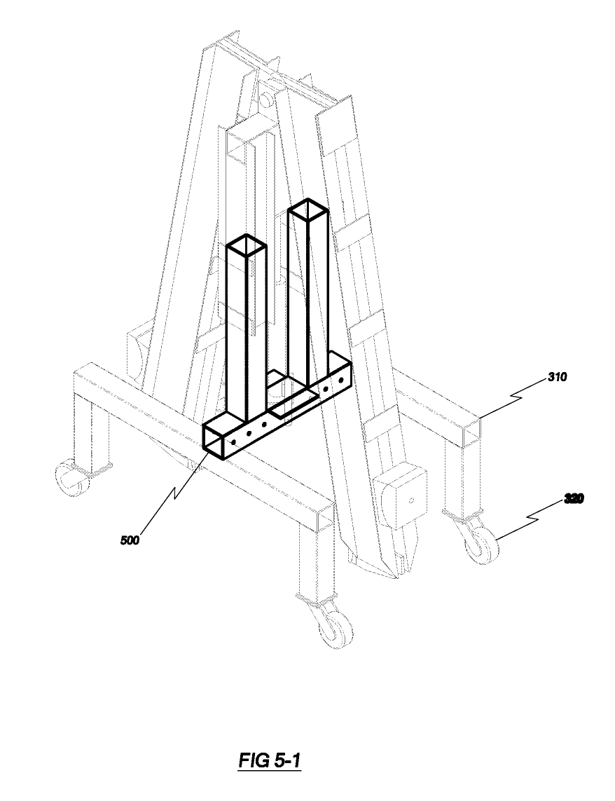

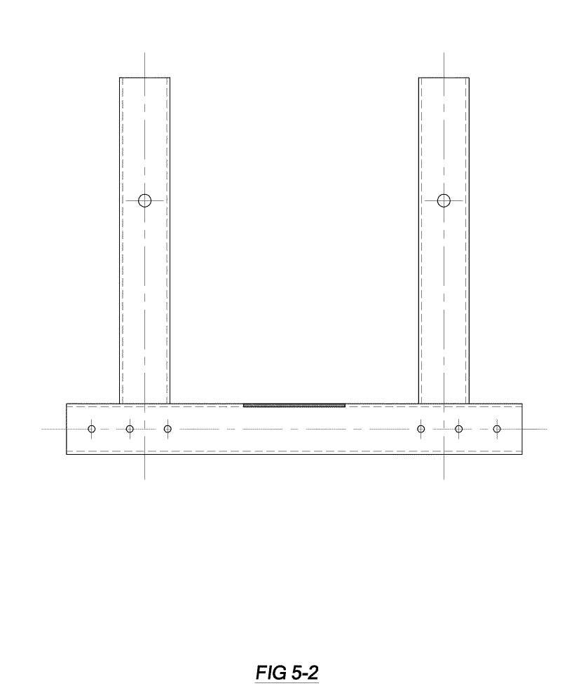

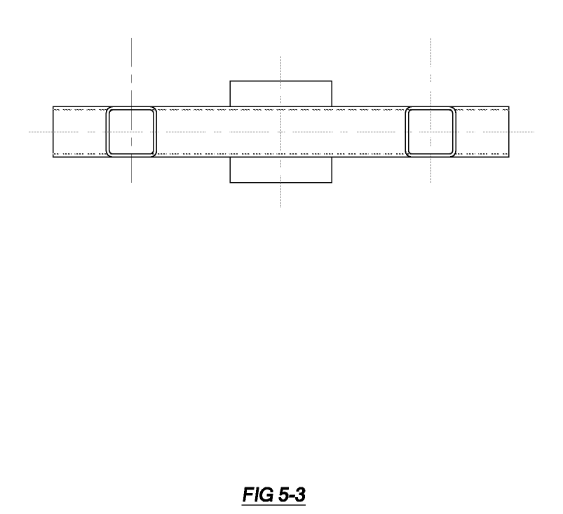

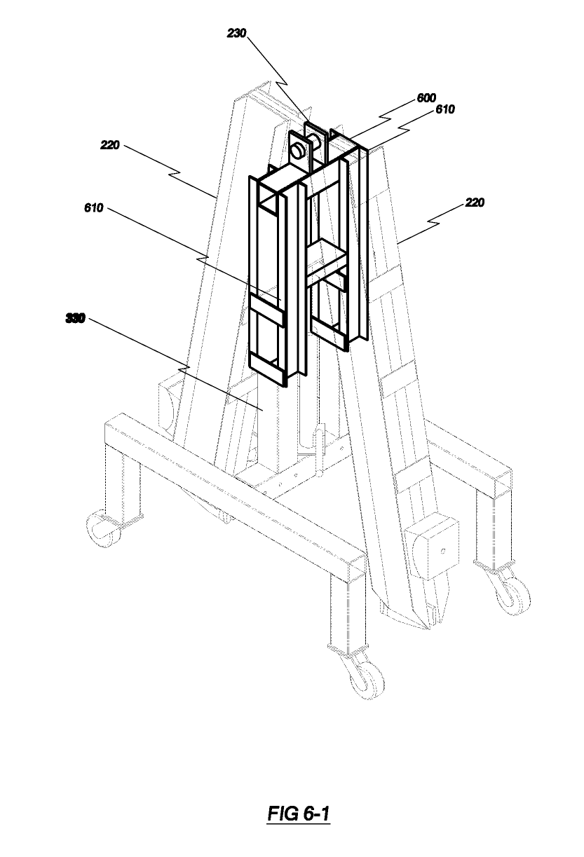

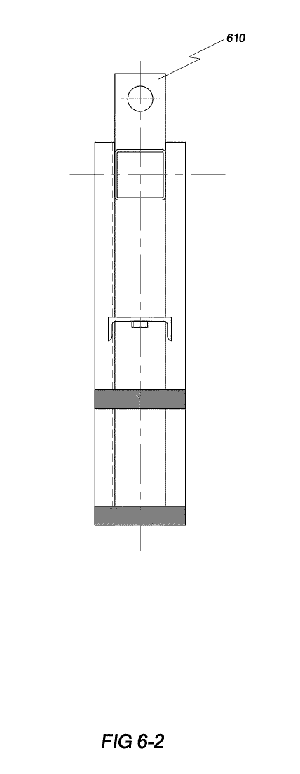

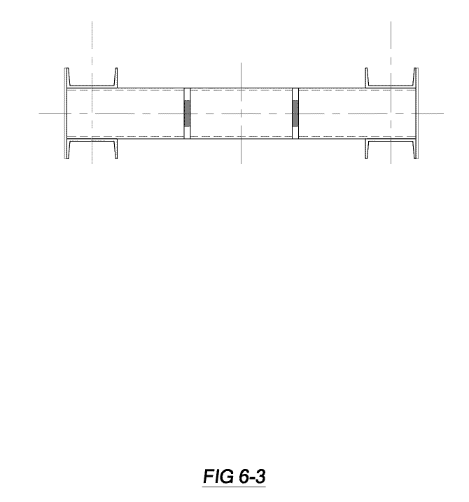

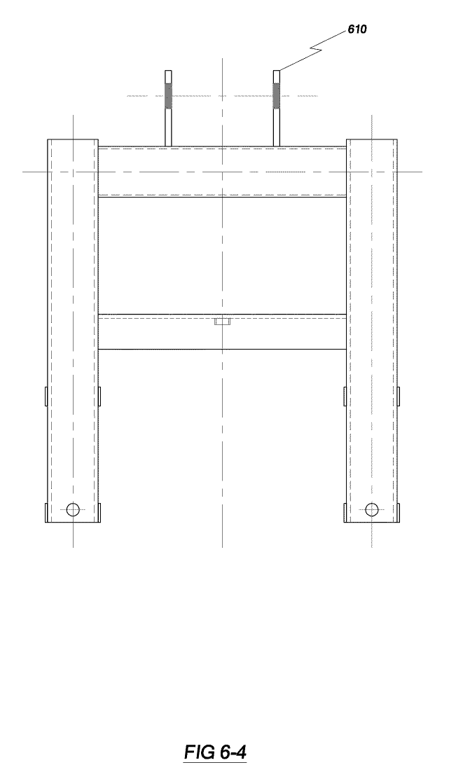

Representative embodiments according to the inventive subject matter are shown in FIGS. 1-7, wherein similar features share common reference numerals.

Referring to FIG. 1 which shows the problem as embodied in the prior art. The slab 110 is desired to be cut to create a hole 120. This hole intersects a tensioning tendon 130 buried in the slab 110. (See diagram “A”). The tensioning tendon 130 requires removal in the area of the hole 120 creating a tendon break 140. (See diagram “B”). Before the tendon 130 is reconnected, the tendon 130 must be retensioned and then connected with a coupler 150. (See diagram “C”). The reconnection of the tendon 130 may require the installation of a stressing chuck 160. After the tendon 130 is reconnected, then a compound is poured into the hole to backfill the slab 170.

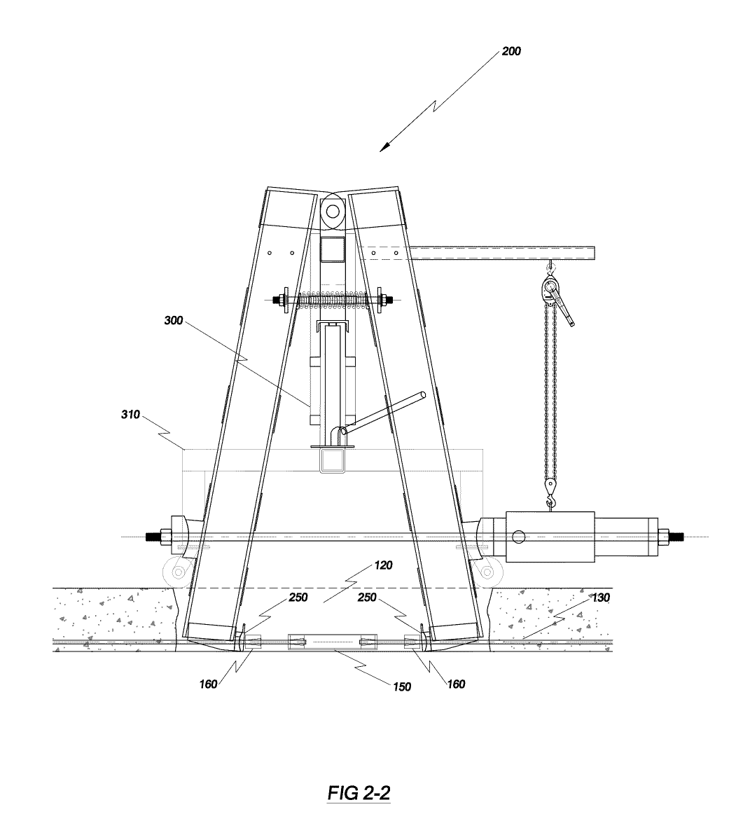

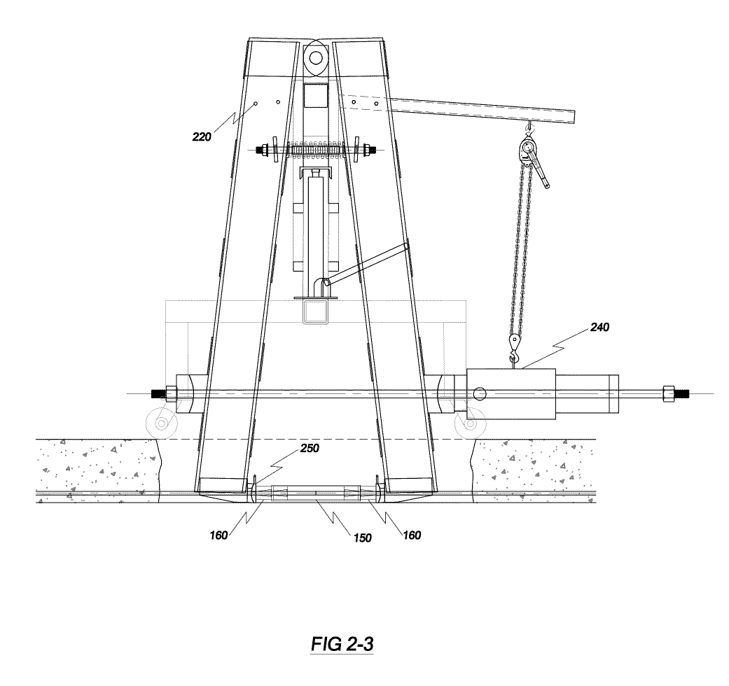

Now referring to FIG. 2-1 which shows the preferred embodiment of the inventive subject matter. A tendon retensioner 200 has a stressing frame 210 has left leg 220′ and a right leg 220″ that are joined at a pivot 230. Beneath the pivot 230 is a return spring 235 (Model McMaster-CARR #9622KC36, McMaster-Carr, 200 New Canton Way Robbinsville, N.J. 08691-2343) exerts an opposing force if the left leg 220′ and the right leg 220″ are brought together. A stressing ram 240 is used to exert a pulling force on a bar 245. The bar 245 is inserted into a shaft on the left leg 220′ with a plate connected and larger than the shaft on the exterior of the left leg 220′. Attached to the cut tendon 130 on either side of the hole is a stressing chuck 160′, 160″. A coupler 150 attaches each side of the tendons 130.

The strength of the components and assembly thereof should be familiar to those skilled in the arts of metal fabrication. Steel framing components should be A36 or A572 as required.

Now referring to FIG. 2-2 which shows the tendon retensioner lowered into the hole 120 adjacent proximate to the unspliced tendon 130. The positioner 300 is connected to a support 310 and allows the tendon retensioner 200 to be raised and lowered into the hole 120. The positioner 300 may be any device that can lift and lower the weight of the upper frame. A positioner 300 that satisfies this criteria is 1.5 ton lifting and lowering RAM manufactured by McMaster-Carr part # 292351)

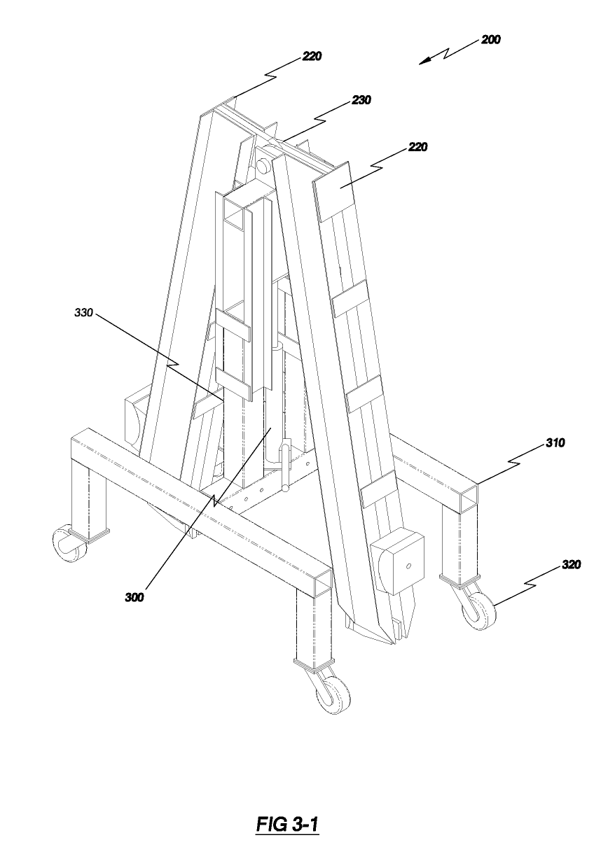

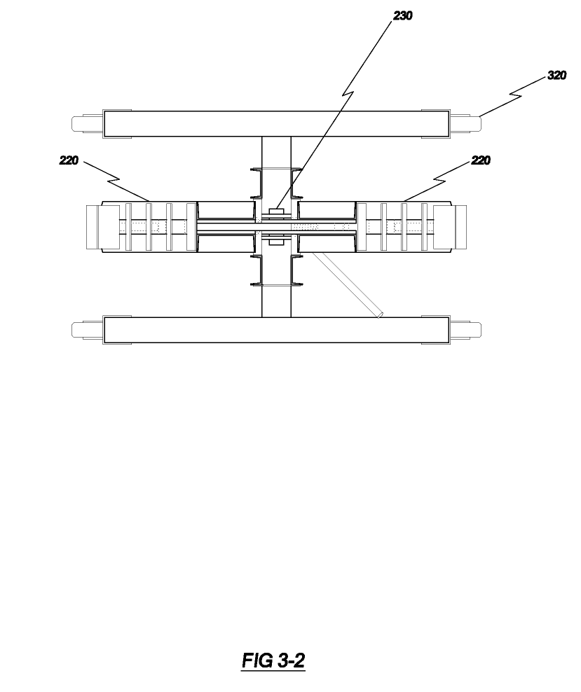

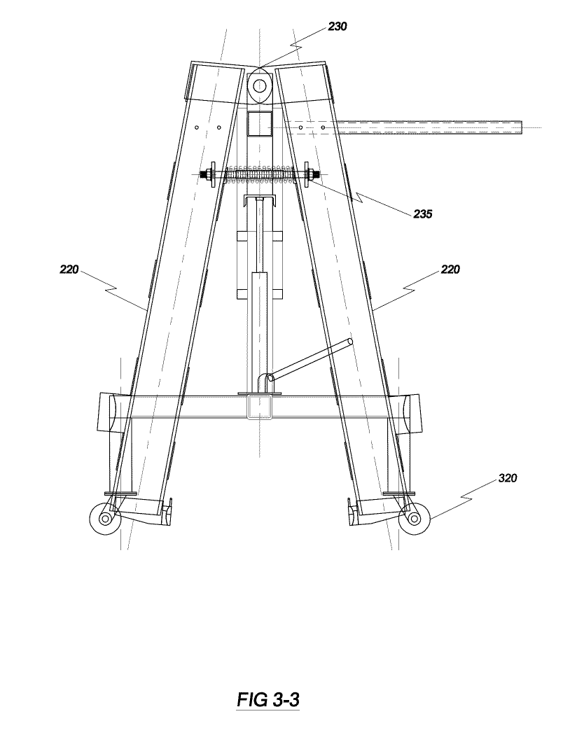

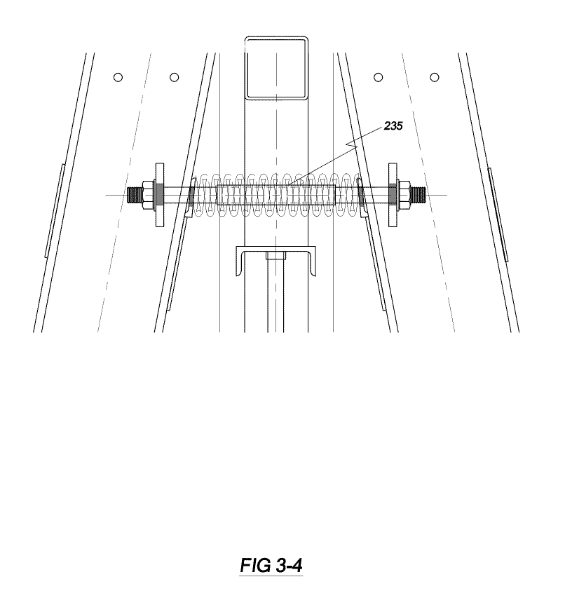

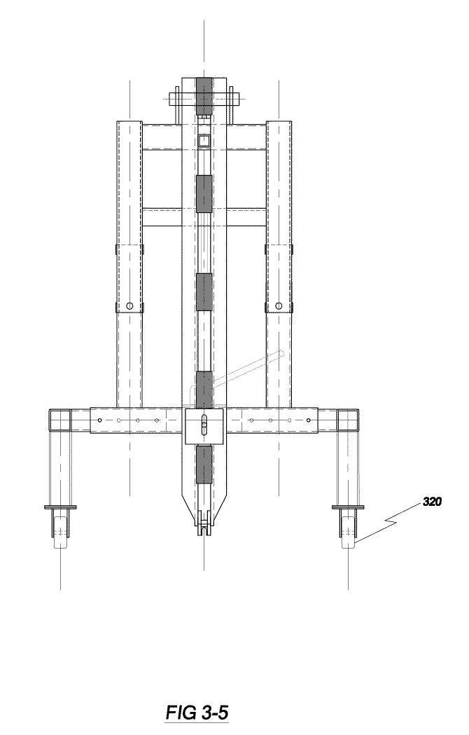

Now referring to FIG. 2-3 which shows the activation of the tendon retensioner. A stressing ram 240 (e.g. a retractor) pulls a bar 245 causing the left leg and the right leg to move inwards. As the bar 245 is pulled the chuck contacts 250 engage the stressing chucks 160′, 160″. The stressing chucks 160′,160″ are pushed inward which in turn retensions the tendons. Each end of the tendon is pushed into the coupler 150 which grips the tendon ends and maintains the tendon force by preventing retraction of the tendon. The stressing ram should be capable of exerting a force of approximately 31,000 lbs if 0.5″ tendon is to be retensioned or 44,000 lbs if 0.6 tendon is to be retensioned.

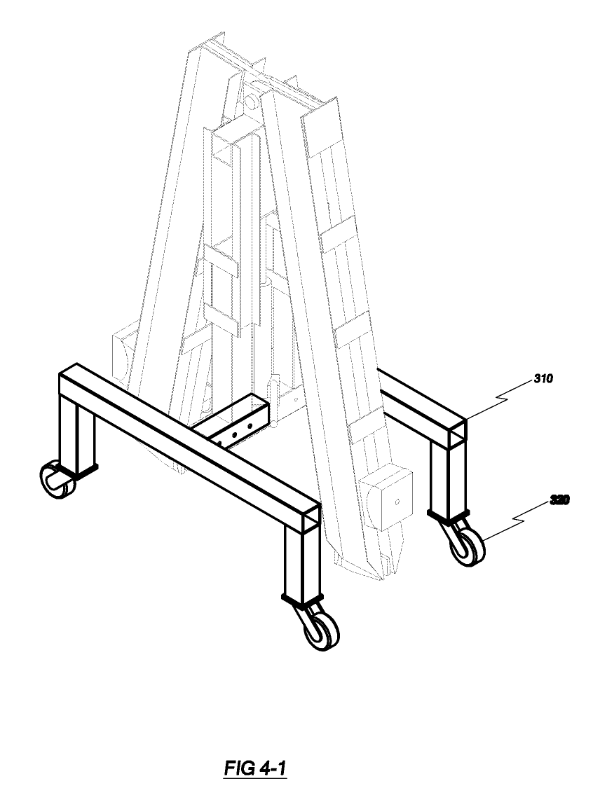

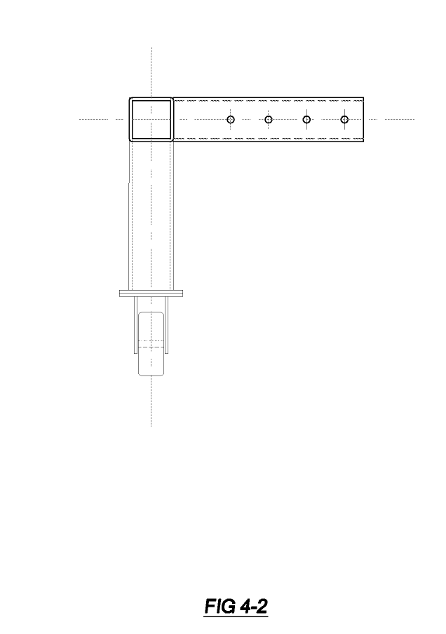

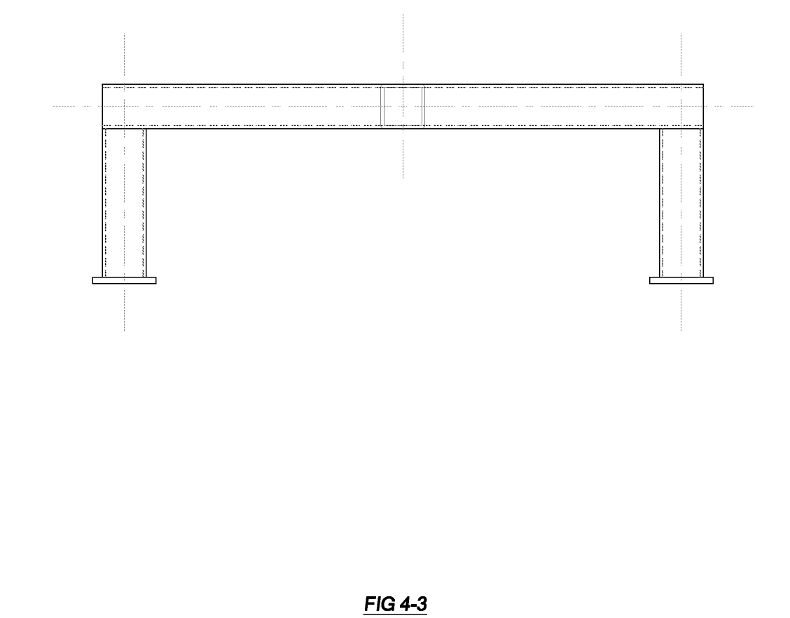

Now referring to FIG. 3-1 which shows a corner view of the tendon retensioner. As shown in FIG. 3-2 which depicts a top view of the tendon retensioner. As shown in FIG. 3-3 which depicts a side view of the tendon retensioner. As shown in FIG. 3-4 which depicts a detailed view of the return spring 235. As shown in FIG. 3-5 which depicts a side view of the retensioner.

Now referring to FIGS. 4-1, 4-2, and 4-3, which shows a detailed view of the member for supporting and movement of the tendon retensioner. The support 310 is attached to the retensioner frame. The support 310 is connected to the caster 320. The caster 320 is of sufficient strength to support the tendon retensioner frame. An embodiment of the caster 320 is a Grainger caster model #1 G283 (W. W. Grainger, Inc., 100 Grainger Parkway, Lake Forest, Ill. 60045-5201)

Now referring to FIGS. 5-1, 5-2, and 5-3, which depict a connecting structure 500 to the support 310. The connecting structure is fabricated from a traditional steel that is of sufficient gauge and strength to support the re-tensioner mechanism.

Now referring to FIGS. 6-1, 6-2, 6-3, and 6-4, which depict an upper support structure 600. The upper support structure 600 has a pair of upper support leaves 610. The upper support structure 600 has two upper support leaves 610 that fit on top of the positioner guides 330. The support leaves 610 and the positioned guides 330 can move relative to each other as the upper support structure 600 is raised or lowered by the positioner 300. The left leg and right leg 220′,200″ are connected at a point at the top of the upper support structure 600. The positioner 300 is connected to the upper support structure 600 via an upper support cross member 620.

Now referring to FIG. 7-1 which depicts the corner view of the left leg and right leg 220″. The left leg 220′ and the right leg 220″ are joined at a pivot 230. At the opposite end of each leg are chuck contacts 250′,250″ that serve to press against the stressing chuck 160 (not shown) when the bar 245 (not shown) is retracted. The chuck contacts 250′, 250″ are shaped to compensate for changes in angle during the splicing process.

The operation of the device involves moving the device over a hole where the tendons have been cut. (See FIG. 2-1). The device is lowered using the positioner 300.

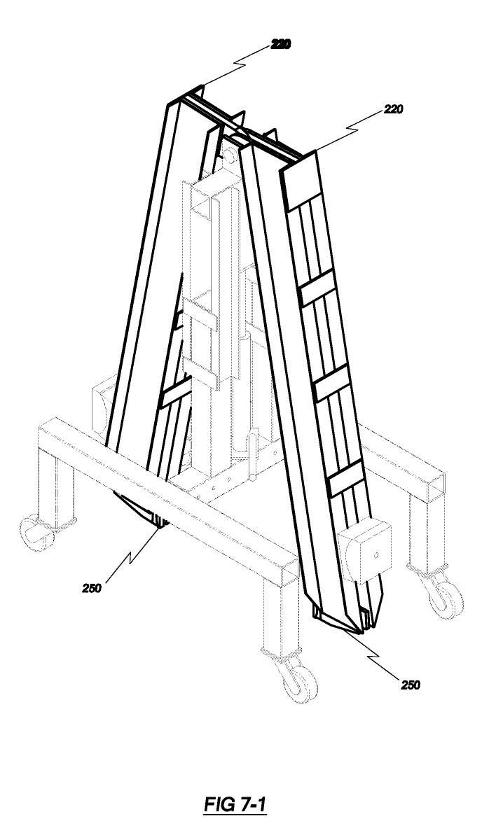

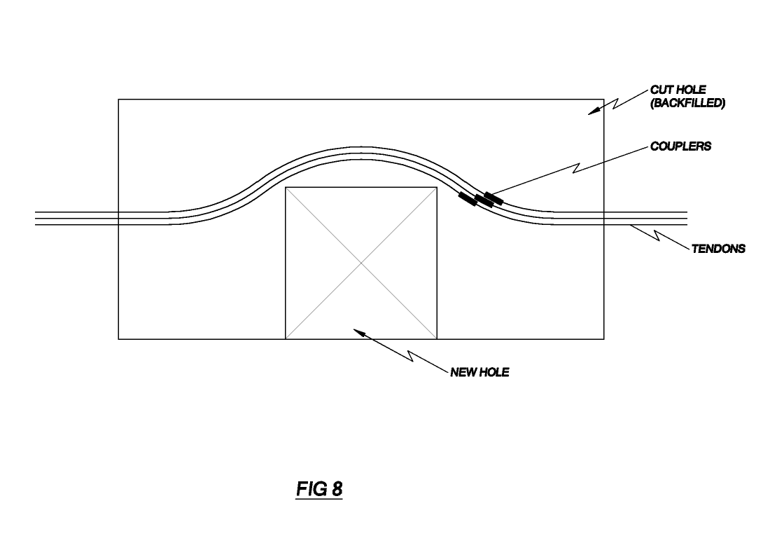

Now referring to FIG. 8 which shows the objective of the tendon splicing system to route tendons around a newly installed hole. The tendons are cut and rerouted around the hole depicted with an “X”.

In the preferred embodiment the dimensions of the tendon retensioner is designed to be placed in a hole that is approximately 4.0 ft by 2.5 ft. The outer dimensions of the support 310 is approximately 6 ft by 3.5 ft. In the preferred embodiment, the support 310 can be wheeled into a standard sized elevator and/or wheeled onto the back of a pickup truck. Furthermore, the device can be lowered using the positioner a distance ranging from 0 to 24″, but, optimally the distance will be 6 inches.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

I claim:

1. An tendon retensioning apparatus comprising:
a stressing frame, the stressing frame comprising:
a first leg and a second leg, the first leg having a top part and a bottom part;
the second leg having a top part and a bottom part;
a pivot connecting the top part of the first leg and the top part of the second leg;
a first chuck contact connected to the bottom part of the first leg, the first chuck contact capable of receiving a first stressing chuck;
a second chuck contact connected to the bottom part of the second leg, the second chuck contact capable of receiving a second stressing chuck;
the first leg further comprising a first shaft for receiving a bar; the bar inserted into the shaft and connected to a plate on the exterior of the first leg;
the second leg further comprising a second shaft for receiving the bar, the bar fixedly attached to a retractor,
so that when the retractor is engaged, the bar is pulled and the first leg and the second leg are pulled inwards engaging the first stressing chuck and the second stressing chuck, such that the first stressing chuck and the second stressing chuck are forceably pulled together.

2. The tendon retensioning apparatus as described in claim 1 wherein the stressing frame further comprises:
a return spring having a first end and a second end;
the first end of the return spring fixably attached to the inside of the first leg;
the second end of return spring fixably attached to the inside of the second leg;
so that when the retractor is engaged and pulling the first leg and the second leg inwards, the return spring is compressed forcing the first leg and second leg outwards when the retractor is disengaged.

3. The tendon retensioning apparatus as described in claim 1 wherein the stressing frame further comprises:
a support, the support capable of resting on a surface;
an upper support structure, said upper support structure mechanically connected to the stressing frame;
a positioner, the positioner having a first end and a second end, such that the positioner can extend and retract as the positioner vertically separates the first end and the second end,
so that when the positioned is vertically separated, the upper support structure and the stressing frame move vertically relative to the surface.

4. The tendon retensioning apparatus as described in claim 3 wherein the support further comprises:
a multiplicity of wheels, the wheels attached at the base of the support and contacting the surface, so that the tendon retensioning apparatus is mobile.

5. The tendon retensioning apparatus as described in claim 4 wherein the positioner is capable of raising and lowering approximately 1.5 tons.

6. The tendon retensioning device as described in claim 1 wherein the apparatus further comprises:
a retractor support, the retractor support mechanically connected between the retractor and the second leg, such that the weight of the retractor support is partially distributed on the second leg.

7. The tendon retensioning device as described in claim 1 wherein the retractor is a powered by an electrical motor.

8. The tendon retensioning device as described in claim 1 wherein the retractor can exert a pulling force of up to 50,000 lbs.

9. The tendon retensioning device as described in claim 1 wherein the stressing frame is from 1 to 5 feet in height.

10. A method of splicing a cut tendon, said method comprising the steps of:
attaching a chuck to each end of the cut tendon, wherein said cut tendon has a first end and a second end;
positioning a tendon retensioning device over the cut tendon,
lowering a portion of the tendon retensioning device over the first end and the second end of the cut tendon moving the legs of the stressing frame inwards,
so that when the legs of the stressing frame are engaged, the chucks are engaged, and
the first tendons and the second tendor are pulled together, allowing the a coupler joins the cut tendons.

11. The method of splicing a tendon according to claim 10 wherein the process of engaging the chucks uses a hydraulic ram.

12. The method of splicing a tendon according to claim 10 where the process of engaging the chucks is an electric motor.

13. The method of engaging the chucks wherein the force applied to engage the chucks ranges from 0 to 50,000 labs

14. The method of claim 10 wherein the method of positioning the tendon retensioning device uses casters.

15. A system for retensioning tendons which comprises:
a means for attaching an stressing ram to each end of a cut piece of a tendon;
a means for engaging the stressing ram,
a means for clamping each end of rebar such that the f while the stressing ram is engaged.

16. The system for retensioning tendons as described in claim 15 further comprising:
a means for raising and lowering the stressing ram.

17. The system for retensioning tendons as described in claim 15 wherein the stressing ram has a maximum force of 50,000 lbs.

18. The system for retensioning tendons as described in claim 15 where the system is mobile.

19. The system for retensioning tendons as described in claim 15 where the stressing ram is electrically powered.
